(19) United States
(12) Patent Application Publication
(10) Pub. No.: US 2025/0056374 A1
(43) Pub. Date: Feb. 13, 2025

(54) Terminal Identification for Communication using Relay Terminal Device

(71) Applicant: Telefonaktiebolaget LM Ericsson (publ), Stockholm (SE)

(72) Inventors: Nithin Srinivasan, Cologne (DE); Zhang Zhang, Beijing (CN); Antonino Orsino, Kirkkonummi (FI); Min Wang, Luleå (SE); Zhang Fu, Stockholm (SE); Liwei Qiu, Täby (SE)

(21) Appl. No.: 18/722,926

(22) PCT Filed: Dec. 19, 2022
(86) PCT No.: PCT/EP2022/086606

§ 371 Date: Jun. 21, 2024

(30) Foreign Application Priority Data
Dec. 22, 2021 (WO) PCT/CN2021/140618

(51) Int. Cl. H04W 40/22; H04W 76/11

(52) U.S. Cl. CPC H04W 40/22; H04W 76/11

(57) ABSTRACT

A first terminal device connects with a second terminal device via at least one third terminal device acting as a relay between the first terminal device and the second terminal device. The first terminal device determines identification information for identifying the first terminal device and/or the second terminal device on a link between the first and second terminal devices. The first terminal device assigns the determined identification information to at least one corresponding hop on the link between the first terminal device and the second terminal device.

### TECHNICAL FIELD

Embodiments of the disclosure generally relate to communication, and, more particularly, to methods and apparatuses for communication using relay terminal device.

### BACKGROUND

This section introduces aspects that may facilitate better understanding of the present disclosure. Accordingly, the statements of this section are to be read in this light and are not to be understood as admissions about what is in the prior art or what is not in the prior art.

Sidelink transmissions over new radio (NR) are specified for release 16 (Rel. 16). These are enhancements of the proximity-based services (ProSe) specified for long term evolution (LTE). Four new enhancements are particularly introduced to NR sidelink transmissions.

First, support for unicast and groupcast transmissions are added in NR sidelink. For unicast and groupcast, the physical sidelink feedback channel (PSFCH) is introduced for a receiver user equipment (UE) to reply the decoding status to a transmitter UE. Second, grant-free transmissions, which are adopted in NR uplink transmissions, are also provided in NR sidelink transmissions, to improve the latency performance. Third, to alleviate resource collisions among different sidelink transmissions launched by different UEs, it enhances channel sensing and resource selection procedures, which also lead to a new design of physical sidelink common control channel (PSCCH). Fourth, to achieve a high connection density, congestion control and thus the quality of service (QOS) management is supported in NR sidelink transmissions.

To enable the above enhancements, new physical channels and reference signals are introduced in NR (available in LTE before). One of the new physical channels is physical sidelink shared channel (PSSCH), which is sidelink (SL) version of physical downlink shared channel (PDSCH). The PSSCH is transmitted by a sidelink transmitter UE, which conveys sidelink transmission data, system information blocks (SIBs) for radio resource control (RRC) configuration, and a part of the sidelink control information (SCI). Another one of the new physical channels is PSFCH. The PSFCH is transmitted by a sidelink receiver UE for unicast and groupcast, which conveys 1 bit information over 1 resource block (RB) for the hybrid automatic repeat request (HARQ) acknowledgement (ACK) and the negative ACK (NACK). In addition, channel state information (CSI) is carried in the medium access control (MAC) control element (CE) over the PSSCH instead of the PSFCH. Yet another one of the new physical channels is PSCCH, which is SL version of physical downlink control channel (PDCCH). When the traffic to be sent to a receiver UE arrives at a transmitter UE, the transmitter UE should first send the PSCCH, which conveys a part of sidelink control information (SCI, SL version of downlink control information (DCI)) to be decoded by any UE for the channel sensing purpose, including the reserved time-frequency resources for transmissions, demodulation reference signal (DMRS) pattern and antenna port, etc.

One of the new reference signals is sidelink primary/secondary synchronization signal (S-PSS/S-SSS). Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitting the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (UE or evolved node B (eNB) or next generation node B (gNB)) sending the S-PSS/S-SSS is called a synchronization source. There are 2 S-PSS sequences and 336 S-SSS sequences forming a total of 672 SSIDs in a cell.

Yet another one of the new physical channels is physical sidelink broadcast channel (PSBCH). The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured bandwidth part (BWP). The PSBCH conveys information related to synchronization, such as the direct frame number (DFN), indication of the slot and symbol level time resources for sidelink transmissions, in-coverage indicator, etc. The SSB is transmitted periodically at every 160 ms.

Some of the new reference signals are DMRS, phase tracking reference signal (PT-RS), channel state information reference signal (CSIRS). These physical reference signals supported by NR downlink/uplink transmissions are also adopted by sidelink transmissions. Similarly, the PT-RS is only applicable for frequency range 2 (FR2) transmission.

Another new feature is two-stage sidelink control information (SCI). This is a version of the DCI for SL. Unlike the DCI, only part (first stage) of the SCI is sent on the PSCCH. This part is used for channel sensing purposes (including the reserved time-frequency resources for transmissions, DMRS pattern and antenna port, etc.) and can be read by all UEs while the remaining (second stage) scheduling and control information such as a 8-bits source identity (ID) and a 16-bits destination ID, new data indicator (NDI), redundancy version (RV) and HARQ process ID is sent on the PSSCH to be decoded by the receiver UE.

Similar as for PROSE in LTE, NR sidelink transmissions have two modes of resource allocations. In the first mode (Mode 1), sidelink resources are scheduled by a gNB. In the second mode (Mode 2), the UE autonomously selects sidelink resources from a (pre-) configured sidelink resource pool(s) based on the channel sensing mechanism. For the in-coverage UE, a gNB can be configured to adopt Mode 1 or Mode 2. For the out-of-coverage UE, only Mode 2 can be adopted.

As in LTE, scheduling over the sidelink in NR is done in different ways for Mode 1 and Mode 2. Mode 1 supports two kinds of grants. The first kind of grant is dynamic grant. When the traffic to be sent over sidelink arrives at a transmitter UE, this UE should launch the four-message exchange procedure to request sidelink resources from a gNB (scheduling request (SR) on uplink (UL), grant, buffer status report (BSR) on UL, grant for data on SL sent to UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the downlink control information (DCI) conveyed by PDCCH with cyclic redundancy check (CRC) scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single transport block (TB). As a result, this kind of grant is suitable for traffic with a loose latency requirement.

The second kind of grant is configured grant. For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE should perform blind decoding to identify the presence of PSCCH and find the resources for the PSSCH through the SCI. When a transmitter UE launches the PSCCH, CRC is also inserted in the SCI without any scrambling.

In the Mode 2 resource allocation, when traffic arrives at a transmitter UE, this transmitter UE should autonomously select resources for the PSCCH and the PSSCH. To further minimize the latency of the feedback HARQ ACK/NACK transmissions and subsequent retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE should select resources for the following transmissions: 1) the PSSCH associated with the PSCCH for initial transmission and blind retransmissions; and 2) the PSSCH associated with the PSCCH for retransmissions.

Since each transmitter UE in sidelink transmissions should autonomously select resources for the above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring reference signal receiving power (RSRP) on different subchannels and requires knowledge of the different UEs power levels of DMRS on the PSSCH or the DMRS on the PSCCH depending on the configuration. This information is known only after receiver SCI launched by (all) other UEs. The sensing and selection algorithm is rather complex.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for communication using relay terminal device. In particular, one of the problems to be solved by the disclosure is that the existing solution for UE-to-network relay cannot be reused for UE-to-UE relay and thus there is a need for a new solution for UE-to-UE relay.

According to a first aspect of the disclosure, there is provided a method performed by a first terminal device. The first terminal device may connect with a second terminal device via at least one third terminal device acting as a relay between the first terminal device and the second terminal device. The method may comprise determining, for the first terminal device and/or the second terminal device, identification information for identifying the first terminal device and/or the second terminal device on a link between the first and second terminal devices. The method may further comprise assigning the determined identification information to at least one corresponding hop on the link between the first and second terminal devices.

In this way, it is possible to perform secure communication on the link with the identification information.

The identification information may have the purpose of being applied during a procedure for establishment of the link and/or after establishment of the link. In some scenarios, the procedure for establishment of the link could also fail.

In an embodiment of the disclosure, assigning the determined identification information may comprises transmitting, to the terminal device on the at least one corresponding hop, a time stamp or a forbid timer associated with the identification information. The time stamp may indicate when the identification information is determined, and the forbid timer may indicate a predetermined time period during which the identification information should not be updated.

In an embodiment of the disclosure, the method may further comprise determining whether the identification information needs to be updated. When determining that the identification information needs to be updated, the determining and assigning of the identification information may be performed again.

In an embodiment of the disclosure, the method may further comprise detecting a conflict between the identification information of at least two different terminal devices, based on transmissions initiated by one or more neighbor terminal devices of the first terminal device. The method may further comprise informing the one or more neighbor terminal devices or a base station of the detected conflict.

In an embodiment of the disclosure, the identification information of the first terminal device and/or the second terminal device may be determined in one or more following manners: based on a layer 2 (L2) identifier (ID) of the first terminal device and/or the second terminal device; in a random manner; and based on a predetermined mathematical function.

In an embodiment of the disclosure, the identification information of the first/second terminal device may be determined to be in one-to-one mapping to an L2 ID of the first/second terminal device.

In an embodiment of the disclosure, the first terminal device may be a source terminal device. Determining the identification information may comprise determining a first temporary ID of the first terminal device. The first temporary ID of the first terminal device is to be used during a link between the first/second terminal device and one of the at least one third terminal device is established.

In an embodiment of the disclosure, the first terminal device may be a destination terminal device. Determining the identification information may comprise determining a first temporary ID of the second terminal device. The first temporary ID of the second terminal device is to be used during a link between the second/first terminal device and one of the at least one third terminal device is established.

In an embodiment of the disclosure, the first terminal device may be a source terminal device or a destination terminal device. Determining the identification information may comprise determining a second temporary ID of the first terminal device and/or the second terminal device. The second temporary ID of the first terminal device and/or the second terminal device is to be used after a link between the first/second terminal device and one of the at least one third terminal device is established.

In an embodiment of the disclosure, the second temporary ID of the first terminal device and/or the second terminal device may be valid for the whole link between the first and second terminal devices.

In an embodiment of the disclosure, assigning the determined identification information may comprise transmitting, to the at least one third terminal device and the second terminal device, the determined identification information and an ID identifying the link between the first and second terminal devices.

In an embodiment of the disclosure, the method may further comprise receiving, from the second terminal device, a response message in response to the assigning of the identification information. When the response message indicates a rejection against the identification information of the second terminal device, the determining and assigning of the identification information may be performed again for the second terminal device.

In an embodiment of the disclosure, the second temporary ID of the first terminal device may be valid for a hop between the first terminal device and one of the at least one third terminal device.

In an embodiment of the disclosure, assigning the determined identification information may comprise transmitting, to the one of the at least one third terminal device, the determined identification information of the first terminal device.

In an embodiment of the disclosure, the first terminal device may be a destination terminal device. The method may further comprise, in response to a reception of a direct communication request (DCR) message, determining whether the DCR message contains the identification information of the second terminal device. The method may further comprise, when the DCR message contains the identification information of the second terminal device, determining that the DCR message is transmitted from the second terminal device via one of the at least one third terminal device. The method may further comprise, when the DCR message does not contain the identification information of the second terminal device, determining that the DCR message is directly transmitted from the second terminal device.

In an embodiment of the disclosure, the determined identification information may be assigned by one or more of: radio resource control (RRC) signaling; PC5 signaling (PC5-S) signaling; Discovery signaling; medium access control (MAC) control element (CE); control protocol data unit (PDU) of service data adaptation protocol (SDAP) or packet data convergence protocol (PDCP) or radio link control (RLC) or an adaptation layer; and layer 1 (L1) signaling.

According to a second aspect of the disclosure, there is provided a method performed by a third terminal device. The third terminal device may act as a relay between a first terminal device and a second terminal device. The method may comprise determining, for the first terminal device and/or the second terminal device, identification information for identifying the first terminal device and/or the second terminal device on a link between the first and second terminal devices. The method may further comprise assigning the determined identification information to at least one corresponding hop on the link between the first and second terminal devices.

In this way, it is possible to perform secure communication on the link with the identification information.

The identification information may have the purpose of being applied during a procedure for establishment of the link and/or after establishment of the link. In some scenarios, the procedure for establishment of the link could also fail.

In an embodiment of the disclosure, assigning the determined identification information may comprise transmitting, to the terminal device on the at least one corresponding hop, a time stamp or a forbid timer associated with the identification information. The time stamp may indicate when the identification information is determined, and the forbid timer may indicate a predetermined time period during which the identification information should not be updated.

In an embodiment of the disclosure, the method may further comprise determining whether the identification information needs to be updated. When determining that the identification information needs to be updated, the determining and assigning of the identification information may be performed again.

In an embodiment of the disclosure, the method may further comprise detecting a conflict between the identification information of at least two different terminal devices, based on transmissions initiated by one or more neighbor terminal devices of the third terminal device. The method may further comprise informing the one or more neighbor terminal devices or a base station of the detected conflict.

In an embodiment of the disclosure, the method may further comprise maintaining a mapping between the identification information of the first/second terminal device applied on an ingress hop of the third terminal device and the identification information of the first/second terminal device applied on an egress hop of the third terminal device.

In an embodiment of the disclosure, the identification information of the first terminal device and/or the second terminal device may be determined in one or more following manners: based on an L2 ID of the third terminal device; in a random manner; and based on a predetermined mathematical function.

In an embodiment of the disclosure, the identification information of the first/second terminal device may be determined to be in one-to-one mapping to an L2 ID of the first/second terminal device.

In an embodiment of the disclosure, the first terminal device may be a source terminal device. Determining the identification information may comprise determining a first temporary ID of the first terminal device. The first temporary ID of the first terminal device is to be used during a link between the first terminal device and the third terminal device is established.

In an embodiment of the disclosure, the second terminal device may be a source terminal device. Determining the identification information may comprise determining a first temporary ID of the second terminal device. The first temporary ID of the second terminal device is to be used during a link between the second terminal device and the third terminal device is established.

In an embodiment of the disclosure, the method may further comprise, in response to a reception of a DCR message from the source terminal device, transmitting another DCR message containing the first temporary ID of the source terminal device on behalf of the source terminal device.

In an embodiment of the disclosure, the first terminal device may be a source terminal device or a destination terminal device. Determining the identification information may comprise determining second temporary IDs of the first terminal device and the second terminal device. The second temporary IDs of the first terminal device and the second terminal device are to be used after a link between the first/second terminal device and the third terminal device is established.

In an embodiment of the disclosure, the second temporary IDs of the first terminal device and the second terminal device may be valid for the whole link between the first and second terminal devices.

In an embodiment of the disclosure, assigning the determined identification information may comprise transmitting, to the other terminal devices on the link between the first and second terminal devices, the determined identification information and an ID identifying the link between the first and second terminal devices.

In an embodiment of the disclosure, different second temporary ID of the first terminal device may be determined for each hop on the link between the first and second terminal devices. Different second temporary ID of the second terminal device may be determined for each hop on the link between the first and second terminal devices.

In an embodiment of the disclosure, assigning the determined identification information may comprise transmitting, to the terminal device on each hop, the identification information of the first and second terminal devices determined for the hop, and an ID identifying the hop.

In an embodiment of the disclosure, the method may further comprise receiving, from the first/second terminal device, a response message in response to the assigning of the identification information. When the response message indicates a rejection against the identification information of the first/second terminal device, the determining and assigning of the identification information may be performed again for the first/second terminal device.

In an embodiment of the disclosure, the determined identification information may be assigned by one or more of: RRC signaling; PC5-S signaling; Discovery signaling; MAC CE; control PDU of SDAP or PDCP or RLC or an adaptation layer; and L1 signaling.

According to a third aspect of the disclosure, there is provided a method performed by a manager terminal device. The manager terminal device may be under coverage of a base station and may be one of a first terminal device, a second terminal device and at least one third terminal device acting as a relay between the first and second terminal devices. The method may comprise reporting, to the base station, information related to a link between the first and second terminal devices. The method may further comprise receiving, from the base station, identification information of the first terminal device and the second terminal device for identifying the first terminal device and the second terminal device on the link between the first and second terminal devices. The method may further comprise assigning the determined identification information to corresponding hops on the link between the first and second terminal devices.

In this way, it is possible to perform secure communication on the link with the identification information.

The identification information may have the purpose of being applied during a procedure for establishment of the link and/or after establishment of the link. In some scenarios, the procedure for establishment of the link could also fail.

In an embodiment of the disclosure, the information related to the link between the first and second terminal devices may comprises one or more of: a number of hops on the link; an L2 ID of the first terminal device; an L2 ID of the second terminal device; an L2 ID of remaining third terminal device(s) in a case that a number of the at least one third terminal device is more than one; a Uu ID of the first terminal device; a Uu ID of the second terminal device; a Uu ID of remaining third terminal device(s) in a case that the number of the at least one third terminal device is more than one; and whether the identification information is valid on per-hop level or on end-to-end level.

In an embodiment of the disclosure, the information related to the link may be reported or the identification information may be received by one or more of: RRC signaling; MAC CE; paging message; control PDU of SDAP or PDCP or RLC or an adaptation layer; and L1 signaling.

In an embodiment of the disclosure, the method may further comprise providing user data and forwarding the user data to a host computer via the transmission to the base station.

According to a fourth aspect of the disclosure, there is provided a method performed by a base station. The base station connects with a manager terminal device which may be one of a first terminal device, a second terminal device and at least one third terminal device acting as a relay between the first and second terminal devices. The method may comprise receiving, from the manager terminal device, information related to a link between the first and second terminal devices. The method may further comprise determining, for the first terminal device and the second terminal device, identification information for identifying the first terminal device and the second terminal device on the link between the first and second terminal devices. The method may further comprise assigning the determined identification information to the manager terminal device.

In this way, it is possible to perform secure communication on the link with the identification information.

The identification information may have the purpose of being applied during a procedure for establishment of the link and/or after establishment of the link. In some scenarios, the procedure for establishment of the link could also fail.

In an embodiment of the disclosure, the information related to the link between the first and second terminal devices may comprise one or more of: a number of hops on the link; an L2 ID of the first terminal device; an L2 ID of the second terminal device; an L2 ID of remaining third terminal device(s) in a case that a number of the at least one third terminal device is more than one; a Uu ID of the first terminal device; a Uu ID of the second terminal device; a Uu ID of remaining third terminal device(s) in a case that the number of the at least one third terminal device is more than one; and whether the identification information is valid on per-hop level or on end-to-end level.

In an embodiment of the disclosure, assigning the determined identification information may comprise transmitting, to the manager terminal device, a time stamp or a forbid timer associated with the identification information. The time stamp may indicate when the identification information is determined, and the forbid timer may indicate a predetermined time period during which the identification information should not be updated.

In an embodiment of the disclosure, the method may further comprise determining whether the identification information needs to be updated. When determining that the identification information needs to be updated, the determining and assigning of the identification information may be performed again.

In an embodiment of the disclosure, the method may further comprise detecting a conflict between the identification information of at least two different terminal devices. The method may further comprise informing one or more neighbor base stations of the base station or a network node of the detected conflict.

In an embodiment of the disclosure, the identification information of the first/second terminal device may be determined in one or more following manners: based on an L2 ID of the first/second terminal device; in a random manner; and based on a predetermined mathematical function.

In an embodiment of the disclosure, the identification information of the first/second terminal device may be determined to be in one-to-one mapping to an L2 ID of the first/second terminal device.

In an embodiment of the disclosure, the method may further comprise receiving, from the first/second terminal device, a response message in response to the assigning of the identification information. When the response message indicates a rejection against the identification information of the first/second terminal device, the determining and assigning of the identification information may be performed again for the first/second terminal device.

In an embodiment of the disclosure, the information related to the link may be received or the identification information may be assigned by one or more of: RRC signaling; MAC CE; paging message; control PDU of SDAP or PDCP or RLC or an adaptation layer; and L1 signaling.

In an embodiment of the disclosure, the detected conflict may be informed to the one or more neighbor base stations by one or more of: XnAP signaling; F1AP signaling; and paging message.

According to a fifth aspect of the disclosure, there is provided a first terminal device. The first terminal device may connect with a second terminal device via at least one third terminal device acting as a relay between the first terminal device and the second terminal device. The first terminal device may comprise at least one processor and at least one memory. The at least one memory containing instructions executable by the at least one processor, whereby the first terminal device may be operative to determine, for the first terminal device and/or the second terminal device, identification information for identifying the first terminal device and/or the second terminal device on a link between the first and second terminal devices. The first terminal device may be further operative to assign the determined identification information to at least one corresponding hop on the link between the first and second terminal devices.

In an embodiment of the disclosure, the first terminal device may be operative to perform the method according to the above first aspect.

According to a sixth aspect of the disclosure, there is provided a third terminal device. The third terminal device may act as a relay between a first terminal device and a second terminal device. The third terminal device may comprise at least one processor and at least one memory. The at least one memory may contain instructions executable by the at least one processor, whereby the third terminal device may be operative to determine, for the first terminal device and/or the second terminal device, identification information for identifying the first terminal device and/or the second terminal device on a link between the first and second terminal devices. The third terminal device may be further operative to assign the determined identification information to at least one corresponding hop on the link between the first and second terminal devices.

In an embodiment of the disclosure, the third terminal device may be operative to perform the method according to the above second aspect.

According to a seventh aspect of the disclosure, there is provided a manager terminal device. The manager terminal device may be under coverage of a base station and may be one of a first terminal device, a second terminal device and at least one third terminal device acting as a relay between the first and second terminal devices. The manager terminal device may comprise at least one processor and at least one memory. The at least one memory may contain instructions executable by the at least one processor, whereby the manager terminal device may be operative to report, to the base station, information related to a link between the first and second terminal devices. The manager terminal device may be further operative to receive, from the base station, identification information of the first terminal device and the second terminal device for identifying the first terminal device and the second terminal device on the link between the first and second terminal devices. The manager terminal device may be further operative to assign the determined identification information to corresponding hops on the link between the first and second terminal devices.

In an embodiment of the disclosure, the manager terminal device may be operative to perform the method according to the above third aspect.

According to an eighth aspect of the disclosure, there is provided a base station. The base station may connect with a manager terminal device which may be one of a first terminal device, a second terminal device and at least one third terminal device acting as a relay between the first and second terminal devices. The base station may comprise at least one processor and at least one memory. The at least one memory may contain instructions executable by the at least one processor, whereby the base station may be operative to receive, from the manager terminal device, information related to a link between the first and second terminal devices. The base station may be further operative to determine, for the first terminal device and the second terminal device, identification information for identifying the first terminal device and the second terminal device on the link between the first and second terminal devices. The base station may be further operative to assign the determined identification information to the manager terminal device.

In an embodiment of the disclosure, the manager terminal device may be operative to perform the method according to the above fourth aspect.

According to a ninth aspect of the disclosure, there is provided a computer program product. The computer program product may comprise instructions which when executed by at least one processor, cause the at least one processor to perform the method according to any of the above first to fourth aspects.

According to a tenth aspect of the disclosure, there is provided a computer readable storage medium. The computer readable storage medium may store thereon instructions which when executed by at least one processor, cause the at least one processor to perform the method according to any of the above first to fourth aspects.

According to an eleventh aspect of the disclosure, there is provided a first terminal device. The first terminal device may connect with a second terminal device via at least one third terminal device acting as a relay between the first terminal device and the second terminal device. The first terminal device may comprise a determination module for determining, for the first terminal device and/or the second terminal device, identification information for identifying the first terminal device and/or the second terminal device on a link between the first and second terminal devices. The first terminal device may further comprise an assigning module for assigning the determined identification information to at least one corresponding hop on the link between the first and second terminal devices.

According to a twelfth aspect of the disclosure, there is provided a third terminal device. The third terminal device may act as a relay between a first terminal device and a second terminal device. The third terminal device may comprise a determination module for determining, for the first terminal device and/or the second terminal device, identification information for identifying the first terminal device and/or the second terminal device on a link between the first and second terminal devices. The third terminal device may further comprise an assigning module for assigning the determined identification information to at least one corresponding hop on the link between the first and second terminal devices.

According to a thirteenth aspect of the disclosure, there is provided a manager terminal device. The manager terminal device may be under coverage of a base station and may be one of a first terminal device, a second terminal device and at least one third terminal device acting as a relay between the first and second terminal devices. The manager terminal device may comprise a reporting module for reporting, to the base station, information related to a link between the first and second terminal devices. The manager terminal device may further comprise a reception module for receiving, from the base station, identification information of the first terminal device and the second terminal device for identifying the first terminal device and the second terminal device on the link between the first and second terminal devices. The manager terminal device may further comprise an assigning module for assigning the determined identification information to corresponding hops on the link between the first and second terminal devices.

According to a fourteenth aspect of the disclosure, there is provided a base station. The base station may connect with a manager terminal device which may be one of a first terminal device, a second terminal device and at least one third terminal device acting as a relay between the first and second terminal devices. The base station may comprise a reception module for receiving, from the manager terminal device, information related to a link between the first and second terminal devices. The base station may further comprise a determination module for determining, for the first terminal device and the second terminal device, identification information for identifying the first terminal device and the second terminal device on the link between the first and second terminal devices. The base station may further comprise an assigning module for assigning the determined identification information to the manager terminal device.

According to a fifteenth aspect of the disclosure, there is provided a method implemented in a communication system including a manager terminal device and a base station. The method may comprise steps of the method according to the above third aspect and steps of the method according to the above fourth aspect.

According to a sixteenth aspect of the disclosure, there is provided a communication system including a manager terminal device according to the above seventh or thirteenth aspect and a base station according to the above eighth or fourteenth aspect.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating user plane protocol stack for L2 UE-to-UE Relay;

FIG. 2 is a diagram illustrating control plane protocol stack for L2 UE-to-UE Relay;

FIG. 3 is a flowchart illustrating a method performed by a first terminal device according to an embodiment of the disclosure;

FIG. 4 is a flowchart for explaining the method of FIG. 3;

FIG. 5 is a flowchart for explaining the method of FIG. 3;

FIG. 6 is a flowchart illustrating a method performed by a first terminal device according to an embodiment of the disclosure;

FIG. 7 is a flowchart illustrating a method performed by a first terminal device according to an embodiment of the disclosure;

FIG. 8 is a flowchart illustrating a method performed by a first terminal device according to an embodiment of the disclosure;

FIG. 9 is a flowchart illustrating a method performed by a first terminal device according to an embodiment of the disclosure;

FIG. 10 is a flowchart illustrating a method performed by a third terminal device according to an embodiment of the disclosure;

FIG. 11 is a flowchart for explaining the method of FIG. 10;

FIG. 12 is a further flowchart for explaining the method of FIG. 10;

FIG. 13 is a flowchart illustrating a method performed by a third terminal device according to an embodiment of the disclosure;

FIG. 14 is a flowchart illustrating a method performed by a third terminal device according to an embodiment of the disclosure;

FIG. 15 is a flowchart illustrating a method performed by a third terminal device according to an embodiment of the disclosure;

FIG. 16 is a flowchart illustrating a method performed by a third terminal device according to an embodiment of the disclosure;

FIG. 17 is a flowchart illustrating a method performed by a third terminal device according to an embodiment of the disclosure;

FIG. 18 is a flowchart illustrating a method performed by a manager terminal device according to an embodiment of the disclosure;

FIG. 19 is a flowchart illustrating a method performed by a base station according to an embodiment of the disclosure;

FIG. 20 is a flowchart illustrating a method performed by a base station according to an embodiment of the disclosure;

FIG. 21 is a flowchart illustrating a method performed by a base station according to an embodiment of the disclosure;

FIG. 22 is a flowchart illustrating a method performed by a base station according to an embodiment of the disclosure;

FIG. 23 is a block diagram showing an apparatus suitable for use in practicing some embodiments of the disclosure;

FIG. 24 is a block diagram showing a first terminal device according to an embodiment of the disclosure;

FIG. 25 is a block diagram showing a third terminal device according to an embodiment of the disclosure;

FIG. 26 is a block diagram showing a manager terminal device according to an embodiment of the disclosure;

FIG. 27 is a block diagram showing a base station according to an embodiment of the disclosure;

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

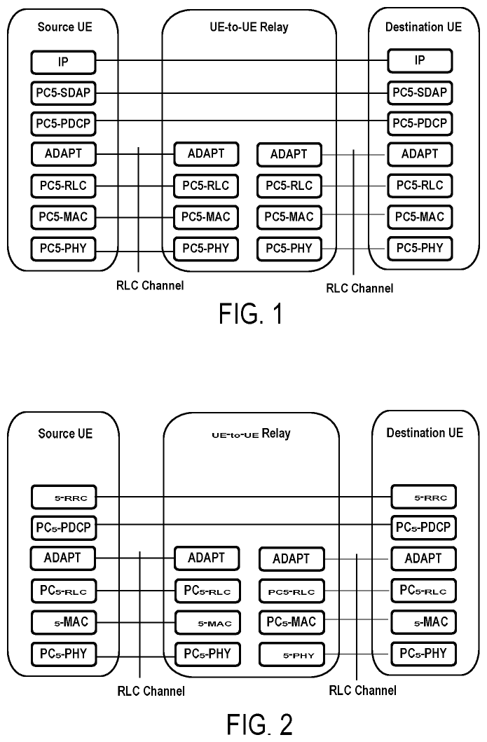

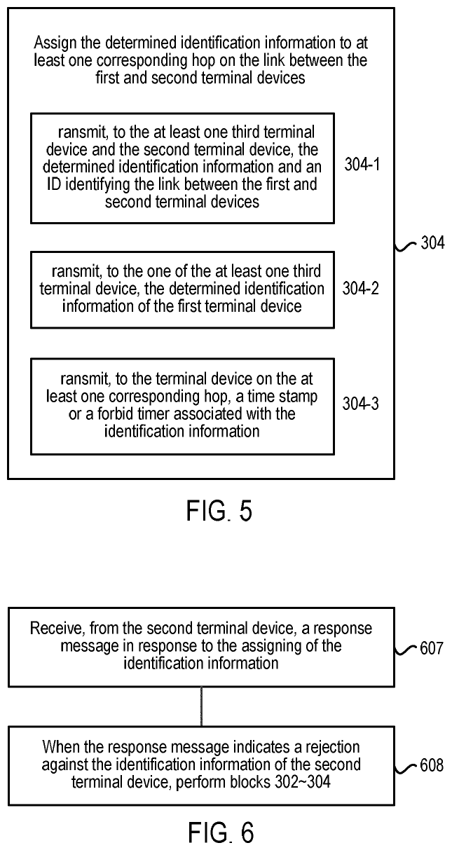

In clause 6.7 of the 3rd generation partnership project (3GPP) technical report (TR) 23.752 V2.0.0, the layer-2 (L2) based UE-to-Network relay is described. In clause 5.5 of the 3GPP TR 38.836 V17.0.0, L2 UE-to-UE relay is described. FIG. 1 and FIG. 2 (which is FIG. 5.5.1-1 and FIG. 5.5.1-2 of TR 38.836 V17.0.0) illustrate the protocol stacks for the user plane and control plane of L2 UE-to-UE Relay architecture. As shown, an adaptation layer is supported over the second PC5 link (i.e. the PC5 link between Relay UE and Destination UE) for L2 UE-to-UE Relay. For L2 UE-to-UE Relay, the adaptation layer is put over radio link control (RLC) sublayer for both control plane (CP) and user plane (UP) over the second PC5 link. The sidelink service data adaptation protocol (SDAP)/packet data convergence protocol (PDCP) and RRC are terminated between two Remote UEs, while RLC, MAC and physical layer (PHY) are terminated in each PC5 link.

For the first hop of L2 UE-to-UE Relay, the N:1 mapping is supported by first hop PC5 adaptation layer between Remote UE SL Radio Bearers and first hop PC5 RLC channels for relaying. The adaptation layer over first PC5 hop between Source Remote UE and Relay UE supports to identify traffic destined to different Destination Remote UEs.

For the second hop of L2 UE-to-UE Relay, the second hop PC5 adaptation layer can be used to support bearer mapping between the ingress RLC channels over first PC5 hop and egress RLC channels over second PC5 hop at Relay UE. PC5 Adaptation layer supports the N:1 bearer mapping between multiple ingress PC5 RLC channels over first PC5 hop and one egress PC5 RLC channel over second PC5 hop and supports the Remote UE identification function.

For L2 UE-to-UE Relay, the identity information of Remote UE end-to-end Radio Bearer is included in the adaptation layer in first and second PC5 hop. In addition, the identity information of Source Remote UE and/or the identity information of Destination Remote UE are candidate information to be included in the adaptation layer, which are to be decided in WI phase.

The 3GPP technical specification (TS) 24.334 V17.2.0 describes Layer-2 ID Conflict Detection/Resolution. As described in clause 11.4.4.1 of TS 24.334 V17.2.0, DIRECT_COMMUNICATION_REJECT message is sent by the UE to another peer UE to indicate that the corresponding direct link setup request has been rejected. Table 1 below is Table 11.4.4.1.1 of TS 24.334 V17.2.0, which shows the message content of DIRECT_COMMUNICATION_REJECT.

TABLE 1
DIRECT_COMMUNICATION_REJECT message content

| IEI | Information Element | Type/Reference | Presence | Format | Length |
|---|---|---|---|---|---|
| | DIRECT_COMMUNICATION_REJECT | PC5-SP | M | V | 1 |
| | message identity | Message Type | | | |
| | | 12.5.1.1. | | | |
| | Sequence Number | Sequence Number | M | V | 2 |
| | | 12.5.1.2 | | | |
| | PC5 Signalling Cause Value | PC5 Signalling | M | V | 1 |
| | | Cause Value | | | |
| | | 12.5.1.7 | | | |

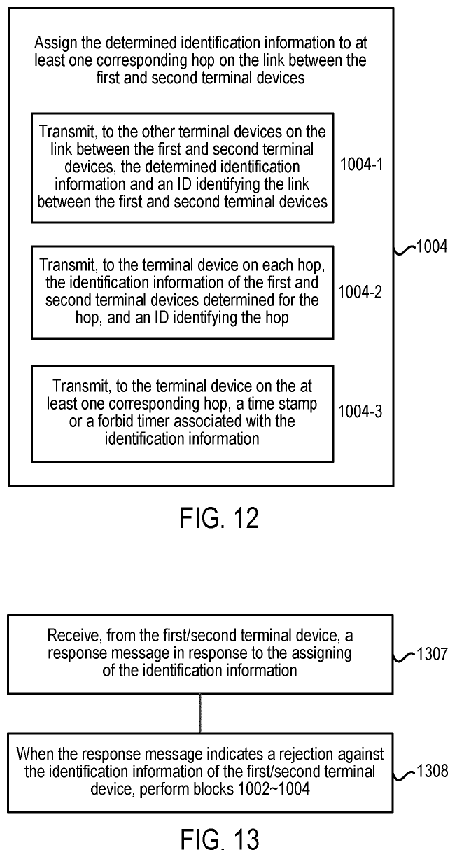

As described in clause 12.5.1.7 of TS 24.334 V17.2.0, the purpose of the PC5 Signaling Protocol Cause Value information element is to indicate the error cause values used in the PC5 Signalling Protocol procedures. The PC5 Signalling Protocol Cause Value is a type 3 information element, with a length of 2 octets. The information element identifier (IEI) of PC5 Signaling Protocol Cause Value IE is 5. Table 2 and Table 3 are FIG. 12.5.1.7.1 and Table 12.5.1.7.1 of TS 24.334 V17.2.0 respectively, which show the coding of the PC5 Signalling Protocol Cause Value information element.

TABLE 2
PC5 Signaling Protocol Cause Value information element

| | | | | | | | |
|---|---|---|---|---|---|---|---|
| 8 | 7 | 6 | 5 | 4 | 3 | 2 | 1 |

| | |
|---|---|
| PC5 Signalling Protocol Cause Value IEI | octet 1 |
| PC5 Signalling Protocol Cause Value Content | octet 2 |

TABLE 3
PC5 Signaling Protocol Cause Value information element
PC5 Signaling Error Cause value (octet 2)

| Bits | | | | |
|---|---|---|---|---|
| 4 | 3 | 2 | 1 | |
| 0 | 0 | 0 | 1 | Direct communication to target UE not allowed |
| 0 | 0 | 1 | 0 | Authentication failure |
| 0 | 0 | 1 | 1 | Conflict of Layer 2 ID for unicast communication is |
| | | | | detected |
| 0 | 1 | 0 | 0 | Lack of resources for proposed link |
| 0 | 1 | 0 | 1 | IP version mismatch |
| 0 | 1 | 1 | 0 | Link setup failure due to other errors |
| 0 | 1 | 1 | 1 | UE security capabilities mismatch |
| 1 | 0 | 0 | 0 | Unspecified error |
| 1 | 0 | 0 | 1 | Authentication synchronisation error |
| 1 | 0 | 1 | 0 | Non-responsive peer during security mode procedure |

All other values are reserved.
Bit 5 to 8 of octet 2 are spare and shall be coded as zero.

In Rel-17 L2 UE-to-Network (U2N) relays, the protocol stack consists of an end-to-end termination of the packet data convergence protocol (PDCP) layer where security is enabled for corresponding protocol data units (PDUs) i.e., including the header information. In addition, a PDCP PDU is carried over two hops i.e., over the first hop (PC5 interface) to a U2N relay and over a second hop (Uu interface) to the gNB/network. Therefore, to facilitate routing over the two hops, the 3GPP has agreed to introduce an adaptation layer at the U2N relay with header information to map the corresponding PDCP PDU from a particular remote UE to the gNB/network. However, this header information is not protected and can be used by malicious attackers to compromise the system. Hence, as a part of this header information, the concept of a local or temporary ID was introduced for the purposes of concealing the real identity of the remote UE. Further, the agreement in the 3GPP is that it is up to gNB implementation how this local/temp ID is generated, maintained and how collision is avoided.

In the case of L2 U2U relays as being discussed in Rel-18, a similar issue exists i.e., header information in the adaption layer is unprotected. However, as the operation of U2U relays can be in either full-coverage, partial coverage, or no-coverage scenarios, the gNB cannot be relied upon to provide the local or temporary (or temp) ID and therefore existing techniques of Rel-17 U2N relays cannot be reused to perform the local/temporary ID assignment.

In addition, the initialization of the U2U relay procedure is the communication of the so-called Direct Communication Request (DCR) message. The DCR is broadcasted in the area by a sidelink source UE to find the suitable sidelink destination UE. However, if the sidelink destination UE is not in the immediate vicinity of the sidelink source UE, this message would need to be relayed by a U2U relay (in vicinity) to the suitable sidelink destination UE. In one case, it is possible that the DCR message from the source sidelink UE is also received in addition to the U2U relay, by the sidelink destination UE. The sidelink destination UE would then need to differentiate the DCRs received from the sidelink source UE and the U2U relay to decide on which path to use.

The present disclosure proposes an improved solution for sidelink transmission. One of the main ideas is to propose new mechanisms on how to allocate the local/temporary ID based on different coverage scenarios as mentioned above for U2U relays. The following three options are mainly proposed to allocate the local/temp ID to a sidelink UE in a U2U relaying scenario to conceal the real identity of a sidelink UE and to protect the system against malicious attacks like denial of service or sidelink UE impersonation.

As the first option, the U2U relay may assign a local ID or temporary ID to the sidelink source/destination UE to be used in the header of the adaptation layer. This local/temp ID is used in both hops between the sidelink source UE and sidelink destination UE. This local/temp ID can either be valid on an end-to-end link or on a per-hop link.

As the second option, depending on the coverage situation of the sidelink UEs performing U2U relaying, this local/temporary ID can be either be assigned by the gNB or generated locally by the U2U relay based on its own sidelink identification i.e., L2 ID and be assigned/allocated to the sidelink source/destination UE.

As the third option, the sidelink source/destination UE may self-assign a local or temporary ID and share this information with the neighboring sidelink U2U relay UEs. The sidelink destination/source UE can also assign a local or temporary ID to the corresponding sidelink source/destination UE.

With any of the above options, the concealment of the real identity of the sidelink source/destination UE can help in preventing malicious attackers from impersonating a sidelink source/destination UE, thereby stopping the use of a denial of service to the real sidelink source/destination UE and preventing compromising the system.

Another one of the main ideas is to address the scenario of differentiating the DCRs. For example, for a sidelink destination UE to differentiate between a DCR from the sidelink source UE and a DCR from the U2U relay, the sidelink source UE can generate an ID uniquely identifying it and pass this information to the U2U relay. The U2U relay then includes this information in the DCR message to the sidelink destination UE. This ID can also be generated by the U2U relay.

The solution of the present disclosure may be applied to a communication system including a terminal device and a base station. The terminal device can communicate through a radio access communication link with the base station. The base station can provide radio access communication links to terminal devices that are within its communication service cell. Note that the communications may be performed between the terminal device and the base station according to any suitable communication standards and protocols.

The term terminal device may also be referred to as, for example, device, access terminal, user equipment (UE), mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, the terminal device may represent a machine or other device that performs monitoring and/or measurements, and transmits the results of such monitoring and/or measurements to another terminal device and/or a network equipment. In this case, the terminal device may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

The term “base station (BS)” may refer to, for example, a node B (NodeB or NB), an evolved Node B (eNodeB or eNB), a next generation Node B (gNodeB or gNB), a multi-standard radio (MSR) radio node such as an MSR BS, a master eNodeB (MeNB), a secondary eNodeB (SeNB), an integrated access backhaul (IAB) node, an access point (AP), a transmission point, a transmission reception point (TRP), a remote radio unit (RRU), a radio header (RH), a remote radio head (RRH), a relay, a low power node such as a femto, a pico, and so forth. For example, a base station may comprise a central unit (CU) including CU user plane (UP) and CU control plane (CP) and one or more distributed units (DUs). The CU and DU(s) may co-locate in a same network node, e.g. a same base station.

Hereinafter, several embodiments will be described to explain the solution of the present disclosure. Although these embodiments are described in the context of NR (i.e., two or more SL UEs are deployed in a same or different NR cell), the same principle may be applied to LTE or any other technology that enables the direct connection of two (or more) nearby devices. The embodiments are also applicable to relay scenarios of UE-to-UE relays where the remote UE and the relay UE may be based on LTE sidelink or NR sidelink, the Uu connection between the relay UE and the base station may be LTE Uu or NR Uu.

Although L2 based U2U relay scenarios are taken for explaining these embodiments, these embodiments are not restricted by any term defined in the disclosure. Any other similar term may be interchangeably applicable here without any loss of the meaning.

### Who Allocates a Local/Temp ID

In the first embodiment, during the link establishment procedure between a sidelink source remote UE and a destination remote UE via a sidelink U2U relay(s), identification information is to be included for unique identification of the sidelink source/destination UEs. This identification information is to be included in the adaptation layer header to allow for the sidelink U2U relay(s) to perform routing of the packets between the sidelink source UE and sidelink destination UE. Further, this identification information can either be generated/allocated by: the sidelink source/destination remote UE; or the sidelink U2U relay; or a gNB, under partial or full coverage of the sidelink UE(s). It is noted that in some scenarios, the link establishment procedure could also fail.

In the second embodiment, the sidelink source/destination UE can generate the identification information in the first embodiment in the form of a local or temporary ID, which is used to identify the sidelink source/destination UE when they communicate with each other via one or multiple relay UEs. This local/temp ID may be generated based on the sidelink source/destination UE ID (i.e., L2 ID), or the local/temp ID may be generated randomly or according to some mathematical function. The sidelink source/destination UE can either assign the local/temp ID on a per-hop level or on an end-to-end level. As an example, the sidelink source UE can generate a local/temp ID for itself and one local/temp ID for the destination UE (if those IDs are used end-to-end). As another example, the sidelink destination UE can generate a local/temp ID for itself and one local/temp ID for the source UE (if those IDs are used end-to-end). As still another example, the sidelink source UE generates the local/temp ID for itself, and the sidelink destination UE generates the local/temp ID for itself (this is valid for both the case when the IDs are used hop-by-hop).

On a per-hop level, the sidelink source/destination UE can generate and self-assign the local/temp ID valid for the link in immediate vicinity. For example, in a single-hop scenario, the sidelink source UE can self-assign a local/temp ID valid only for the first hop between the sidelink source UE and the sidelink U2U relay (i.e., next immediate hop), while the relay UE maps the local/temp ID to another local/temp ID representing the source UE in the second hop between the sidelink U2U relay and the sidelink destination UE. Similarly, the sidelink destination UE also self-assigns another local/temp ID which is valid only for the next immediate hop i.e., the second hop between the sidelink destination UE and the sidelink U2U relay, while the relay UE maps the local/temp ID to another local/temp ID representing the destination UE in the first hop between the sidelink U2U relay and the sidelink source UE. In a multi-hop scenario, the sidelink U2U relay will maintain a separate mapping between the local/temp ID for the source/destination UE applied on each of the ingress hop(s) and the egress hop(s).

On an end-to-end level, the sidelink source/destination UE can generate and self-assign the local/temp ID valid for the entire path i.e., over all hops. For example, in a single-hop scenario, the sidelink source/destination UE can self-assign a local/temp ID valid for the first hop (between the sidelink source UE and sidelink U2U relay) and for the second hop (between the sidelink U2U relay and sidelink destination UE).

In another aspect of this embodiment, the sidelink source/destination UE can assign the local/temp ID to the corresponding sidelink destination/source UE during the end-to-end link establishment procedure. For instance, when the per-hop PC5 connection is established between the source/destination UE and the relay UE, or between all the relay UEs in case of multi-hop, the source/destination UE informs the directly connected relay UE of its local/temp ID and for which end to end link this ID should be used; the end to end link may be represented by the L2 ID of the source/destination UE which is known to the source/destination UE and the relay UE along the path during discovery or after exchange of the initial link establishment request and response message. The relay UE further forwards the local/temp ID and the related end to end link until the message reaches the destination/source UE. In case the local/temp ID is used per hop, the relay UE may regenerate another local/temp ID for the source/destination UE as described above and then forward this regenerated local/temp ID.

In the third embodiment, the sidelink U2U relay is responsible to generate and assign the local/temp ID to the both the sidelink source and destination UEs or other sidelink U2U relay(s) during the link establishment procedure. Like the explanation in the second embodiment, this local/temp ID can either be assigned on a per-hop level or on an end-to-end level.

The partitioning of the local/temp IDs can be based on the sidelink identity information i.e., L2 ID of the sidelink U2U relays, or based on a random generation or based on some mathematical function. In this way, different ID spaces are associated with different relay UEs.

A relay UE assigns different local/temp IDs within its associated ID space to different remote UEs connecting to the relay UE. Remote UEs served by different relay UEs would also have different local/temp IDs since the IDs are belonging to different ID spaces.

In the fourth embodiment, the gNB can be responsible to generate and assign the local/temp ID to the sidelink source/destination UE and/or sidelink U2U relay(s) based on at least one of the following options.

In option 1, depending on which sidelink UE is under the coverage of the gNB, it would be the responsibility of that specific sidelink UE (so-called the ID manager) to assign the local/temp IDs to the other sidelink UEs.

The ID manager can report at least one of the following information elements to the gNB: number of hops; L2 ID of the source/destination UE; L2 ID of the other relay UE(s) along the path in case of multi-hop; any other known Uu ID (e.g., TMSI, RNTI) of the source/destination UE; any other known Uu ID (e.g., TMSI, RNTI) of the other relay UE(s) in case of multi-hop; per-hop or end-to-end local/temp ID assignment information.

Based on this information from the ID manager, the gNB can generate and assign the corresponding local/temp IDs for the source/destination UE and for which hop/path the IDs should be applied in case the ID is assigned per hop. The ID manager should then inform this local/temp IDs to all the UEs along the path, which may follow a similar procedure as described in the second embodiment, i.e., the ID manager informs the local/temp IDs together with the corresponding L2 IDs and the hop on which the local/temp IDs should be applied to its direct neighbor UE(s), which further forwards the information until it reaches the source and/or the destination UE.

In an example, the ID manager can simply be the sidelink source UE. When the sidelink source UE has data incoming and there is a need to use a sidelink U2U relay link, after having discovered the relay UE(s) and the sidelink destination UE, it may send a signaling to the gNB and ask for the local/temp ID. After receiving this information from the gNB, the sidelink source UE can simply inform the relay UE and/or the sidelink destination UE of their local/temp ID during the sidelink relay link establishment procedure.

In option 2, there is no ID manager. Each remote UE or relay UE if connected to the gNB can be assigned with a local/temp ID by the gNB for relay communication. The UE reports similar information as described in the Option 1.

In the fifth embodiment, either the sidelink source/destination UE(s) or sidelink U2U relay(s) can trigger a local/temp ID update procedure. The conditions to trigger such a procedure can include the following: a timer related to the validity of the local ID has expired; one of the sidelink UE(s) in the end-to-end link has triggered a reselection; one of the hops in the end-to-end link has undergone a link failure e.g., one of the sidelink UE(s) has triggered an radio link failure (RLF) procedure; based on signaling received from the gNB/sidelink UE(s); the gNB has changed (i.e., handover procedure has been triggered); a new service/traffic needs to be transmitted (this imply that there could be also a different local/temp ID for each service/traffic that is transmitted).

In case the ID is applied end to end, once the ID is updated, the new ID should be informed to all the UEs along the path by the UE updating the ID, which may follow a similar procedure performed by the ID manager as described in the fourth embodiment. The updating UE may associate the new ID with a time stamp indicating when the ID is updated and optionally a forbid timer indicating that the ID should not be updated again for a certain time period, the other UEs along the path should avoid updating the ID again as long as the forbid timer is running (not expired). Alternatively, when a UE receives a new ID with and older time stamp than the one associated to currently used ID, the UE continues using the current ID.

In case the ID is applied per hop, the above conditions are defined and examined for each hop and the local/temp ID update may be triggered and performed separately and independently for each hop. When an ID applied for a hop is updated, it only needs to be informed to the direct neighbor UE of this hop, i.e., no need to further distribute the new ID to the other UEs along the path. The relevant UEs will then update the ID mapping between the ingress hop and the egress hop.

In another aspect of this embodiment, the ID manager (from the fourth embodiment) based on the above trigger conditions can inform a particular sidelink UE to update its local/temp ID which may not be a direct neighbor UE. In this case, the ID manager can include additional information (for e.g., an L2 ID, previous local/temp ID) to identify that particular sidelink UEs along the path/link in the update message.

In the sixth embodiment, during the link establishment procedure, when a sidelink U2U relay receives a DCR message from the sidelink source UE, the sidelink U2U relay generates/assigns an initial local/temp ID to the sidelink source UE. This may or may not be in addition to the sidelink UE ID i.e., L2 ID of the sidelink source UE. The sidelink U2U relay then transmits another DCR message on behalf of the sidelink source UE including this initial temp/local ID. The sidelink destination UE can then differentiate between the two requests based on the presence or absence of the initial local/temp ID.

In another aspect of this embodiment, the initial local temp ID can also be generated by the sidelink source/destination UE and communicated during a previous PC5-RRC link establishment procedure. The U2U relays in this case also maintains a mapping between the sidelink UE ID i.e., L2 ID and the initial local/temp ID to be used in the DCR message. The initial local/temp ID can also be updated based on the embodiments as discussed herein.

### How to Avoid ID Conflict

In this section, some embodiments on how to address/avoid ID conflict will be described. An event of ID conflict may be declared by a UE or gNB when one of the following conditions is met: at least two SL UEs sharing a same ID within a given area/proximity; at least two SL UEs which are served by the same gNB or different gNBs share a same ID; at least two SL UEs which are served by the same or different relay UEs share a same ID; at least two SL UEs which are interested in the same service share a same ID; at least two SL UEs on a same relay path or different relay paths share a same ID.

An event of ID conflict may be declared for IDs of UEs (including sidelink source/destination UEs and/or U2U relay UEs) including at least one of the following: source L2 ID; destination L2 ID; local/temp UE ID which is used in the adaptation layer in case of SL relay; any other UE ID which is used in PC5-S signaling, PC5 RRC signaling, MAC CE, control PDU of a protocol layer (e.g., SDAP, PDCP, RLC, or the adaptation layer in case of SL relay) or L1 signaling.

In the seventh embodiment, a procedure of detecting ID conflict may be maintained by a UE (e.g., either a sidelink source/destination UE or a sidelink U2U relay). The UE may monitor data transmissions/signaling (regardless whether the transmissions are intending to the UE) initiated by its neighbor UEs to see if there is an ID conflict. Upon detection of an ID conflict, the UE may signal the event to its neighbor UEs and/or the gNB.

As another option, the similar procedure of detecting ID conflict may be maintained by a gNB. The gNB may detect ID conflict based on the signaling message received from UEs or other gNBs. Alternatively, the gNB may also detect ID conflict via monitoring SL transmissions and/or receptions between SL UEs in its proximity. Upon detection of ID conflict, the gNB may signal the event to its neighbor gNBs via inter-gNB signaling. In addition, the gNB may also signal the event to the core network entity such as AMF or SMF. If the gNB is a distributed unit (DU), the gNB may signal the event to the central unit (CU) via CU-DU interface.

In the eighth embodiment, for any one of the above embodiments, during a procedure of local ID/temp ID allocation for a remote UE (e.g., source remote UE or destination remote UE), at least one of the following options is taken by the controlling entity (which is responsible for allocating local ID/temp ID for the remote UE) to avoid ID conflict with other remote UEs. The controlling entity may be a relay UE, a destination remote UE or a gNB. In addition, the controlling entity may also be the ID manager as described in the fourth embodiment.

In Option 1, local ID is one to one mapped to a L2 ID. Since different UEs are mostly likely to be associated with different L2 IDs, the corresponding local ID of each L2 ID will be also different.

In Option 2, whenever a local ID is assigned to the remote UE, the remote UE can indicate acceptance or rejection to the controlling entity. After reception of a local ID from the controlling entity, the remote UE may perform a detection to see if this ID is conflicting with its neighbor UE. If ID conflict is detected, the remote UE indicates rejection to the controlling entity in a response message. Otherwise, the remote UE may accept the ID.

The response message may comprise at least one of the following information: L2 ID of the remote UE which sends the response message; indicator indicating acceptance or rejection to the assigned local ID; rejection cause if rejection is indicated; one or multiple preferred local ID values, based on which the controlling entity may select the most suitable one for the remote UE.

Upon reception of the response message from the remote UE, the controlling entity may determine to reallocate a different local ID. After that, the controlling entity resends the new ID to the remote UE. The remote UE can further check if the new ID is acceptable, i.e., whether there is ID conflict. The procedure may be repeated for multiple times until eventually the remote UE and the controlling entity can agree on an appropriate local ID.

### Signaling Alternatives

In the ninth embodiment, for any of the above embodiments, the signaling alternatives described may include at least one of the below. For signaling between UE and the gNB, at least one of the following signaling alternatives may be applied: RRC signaling; MAC CE; paging message; control PDU of a protocol layer (e.g., SDAP, PDCP, RLC, or an adaptation layer in case of SL relay); L1 signaling on channels such as PRACH, PUCCH, PDCCH.

For signaling between UEs, at least one of the following signaling alternatives may be applied: RRC signaling (e.g., PC5-RRC); PC5-S signaling; Discovery signaling; MAC CE; control PDU of a protocol layer (e.g., SDAP, PDCP, RLC, or an adaptation layer in case of SL relay); L1 signaling on channels such as PSSCH, PSCCH, or PSFCH.

For signaling between gNBs, at least one of the following signaling alternatives may be applied: XnAP signaling; F1AP signaling; paging message.

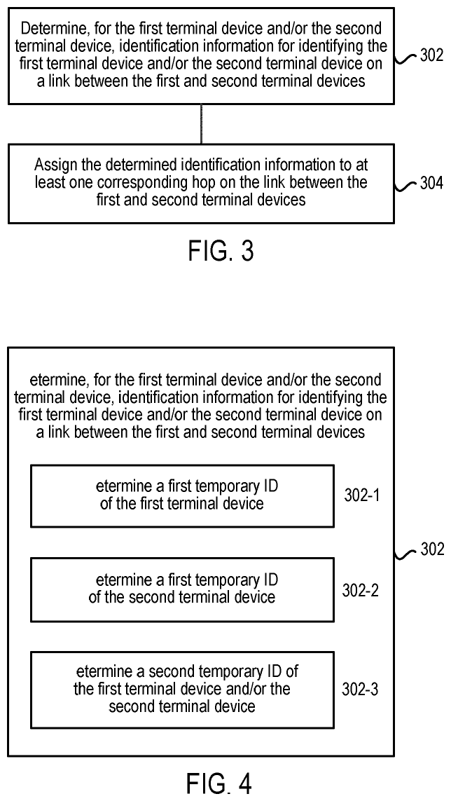

Hereinafter, the solution of the present disclosure will be further described with reference to FIGS. 3-37. FIG. 3 is a flowchart illustrating a method performed by a first terminal device according to an embodiment of the disclosure. The method may be applicable to an environment in which the first terminal device connects with a second terminal device via at least one third terminal device acting as a relay between the first terminal device and the second terminal device. The method may be applied during the process of connecting the first terminal device and/or when the connection is already established, e.g., if the connection needs to be updated. The third terminal device may be a U2U relay as described above. At block 302, the first terminal device determines, for the first terminal device and/or the second terminal device, identification information for identifying the first terminal device and/or the second terminal device on a link between the first and second terminal devices. The identification information of a given terminal device may be used instead of a real identity of the terminal device in communication of packets, so as to conceal the real identity of the terminal device. For example, the identification information of the first/second terminal device may be used in adaptation layer headers of packets communicated on a link between the first and second terminal devices.

For example, block 302 may be implemented as any one of blocks 302-1 to 302-3, as shown in FIG. 4. Block 302-1 is applicable to the scenario where the first terminal device is a source terminal device (and thus the second terminal device is a destination terminal device). At block 302-1, the first terminal device determines a first temporary ID of the first terminal device. The first temporary ID of the first terminal device is to be used during a link between the first/second terminal device and one of the at least one third terminal device is established. For example, the first temporary ID may correspond to the initial local/temp ID described in the above sixth embodiment.

Block 302-2 is applicable to the scenario where the first terminal device is a destination terminal device (and thus the second terminal device is a source terminal device). At block 302-2, the first terminal device determines a first temporary ID of the second terminal device. The first temporary ID of the second terminal device is to be used during a link between the second/first terminal device and one of the at least one third terminal device is established.

Block 302-3 is applicable to the scenario where the first terminal device is a source terminal device or a destination terminal device. At block 302-3, the first terminal device determines a second temporary ID of the first terminal device and/or the second terminal device. The second temporary ID of the first terminal device and/or the second terminal device is to be used after a link between the first/second terminal device and one of the at least one third terminal device is established. For example, the second temporary ID may correspond to the local/temp ID described in the above second to fourth embodiments.

For any one of the above scenarios, the identification information of the first terminal device and/or the second terminal device may be determined in one or more following manners: based on an L2 ID of the first terminal device and/or the second terminal device; in a random manner; and based on a predetermined mathematical function. For example, the identification information of the first/second terminal device may be determined to be in one-to-one mapping to the L2 ID of the first/second terminal device.

Referring back to FIG. 3, at block 304, the first terminal device assigns the determined identification information to at least one corresponding hop on the link between the first and second terminal devices. The determined identification information may be assigned by one or more of: RRC signaling; PC5-S signaling; Discovery signaling; MAC CE; control PDU of SDAP or PDCP or RLC or the adaptation layer; and L1 signaling. With the method of FIG. 3, it is possible to perform secure communication on the link with the identification information. For example, block 304 may be implemented as including any one of blocks 304-1 to 304-3 as shown in FIG. 5. Block 304-1 is applicable to the scenario where the identification information (e.g. the second temporary ID) of the first terminal device and/or the second terminal device is valid for the whole link between the first and second terminal devices. At block 304-1, the first terminal device transmits, to the at least one third terminal device and the second terminal device, the determined identification information and an ID identifying the link between the first and second terminal devices.

Block 304-2 is applicable to the scenario where the second temporary ID of the first terminal device is valid for a hop between the first terminal device and one of the at least one third terminal device. At block 304-2, the first terminal device transmits, to the one of the at least one third terminal device, the determined identification information of the first terminal device.

Optionally, block 304-3 may be performed for assigning of the identification information. At block 304-3, the first terminal device transmits, to the terminal device on the at least one corresponding hop, a time stamp or a forbid timer associated with the identification information. The time stamp indicates when the identification information is determined (or updated). The forbid timer indicates a predetermined time period during which the identification information should not be updated.

FIG. 6 is a flowchart illustrating a method performed by a first terminal device according to an embodiment of the disclosure. The method may be performed after blocks 302-304 are performed. At block 607, the first terminal device receives, from the second terminal device, a response message in response to the assigning of the identification information. At block 608, when the response message indicates a rejection against the identification information of the second terminal device, the determining (block 302) and assigning (block 304) of the identification information are performed again for the second terminal device. With the method of FIG. 6, possible conflict of the identification information can be solved.

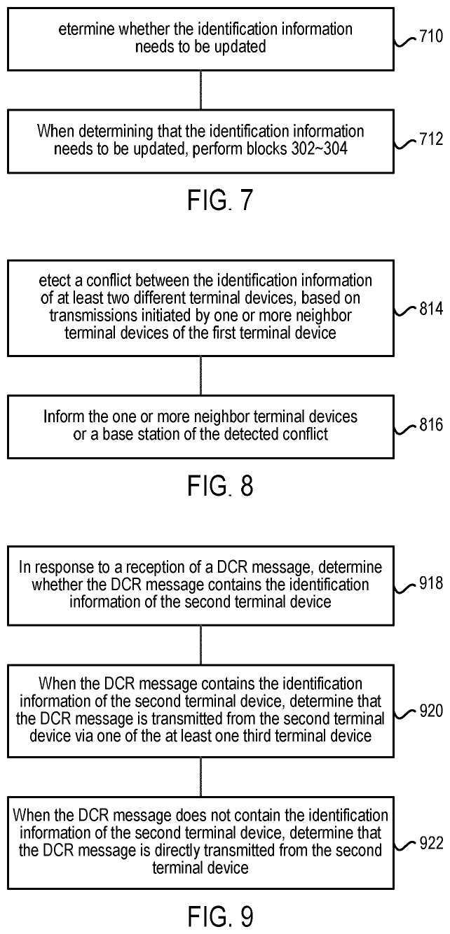

FIG. 7 is a flowchart illustrating a method performed by a first terminal device according to an embodiment of the disclosure. For example, the method may be performed after blocks 302-304 are performed. At block 710, the first terminal device determines whether the identification information needs to be updated. For example, when one or more of the conditions mentioned in the above fifth embodiment are satisfied, the first terminal device may determine that the identification information needs to be updated. At block 712, when determining that the identification information needs to be updated, the determining (block 302) and assigning (block 304) of the identification information are performed again. With the method of FIG. 7, it is possible to perform secure communication on the link with the updated identification information.

FIG. 8 is a flowchart illustrating a method performed by a first terminal device according to an embodiment of the disclosure. At block 814, the first terminal device detects a conflict between the identification information of at least two different terminal devices, based on transmissions initiated by one or more neighbor terminal devices of the first terminal device. For example, the transmissions (e.g. data and/or signaling transmissions) initiated by the one or more neighbor terminal devices may be monitored regardless whether the transmissions are intending to the first terminal device, so as to see whether there is such a conflict. At block 816, the first terminal device informs the one or more neighbor terminal devices or a base station of the detected conflict. With the method of FIG. 8, possible conflict of the identification information can be solved.

FIG. 9 is a flowchart illustrating a method performed by a first terminal device according to an embodiment of the disclosure. The method may be applicable to the scenario where the first terminal device is a destination terminal device (and thus the second terminal device is a source terminal device. At block 918, in response to a reception of a DCR message, the first terminal device determines whether the DCR message contains the identification information (e.g. the above mentioned first temporary ID) of the second terminal device. At block 920, when the DCR message contains the identification information of the second terminal device, the first terminal device determines that the DCR message is transmitted from the second terminal device via one of the at least one third terminal device. As an example, the DCR message may contain both the first temporary ID and the L2 ID of the second terminal device. As another example, the DCR message may contain the first temporary ID of the second terminal device, without containing the L2 ID of the second terminal device. At block 922, when the DCR message does not contain the identification information of the second terminal device, the first terminal device determines that the DCR message is directly transmitted from the second terminal device. With the method of FIG. 9, the destination terminal device can be allowed to differentiate between a DCR from the source terminal device and a DCR from the relay terminal device.

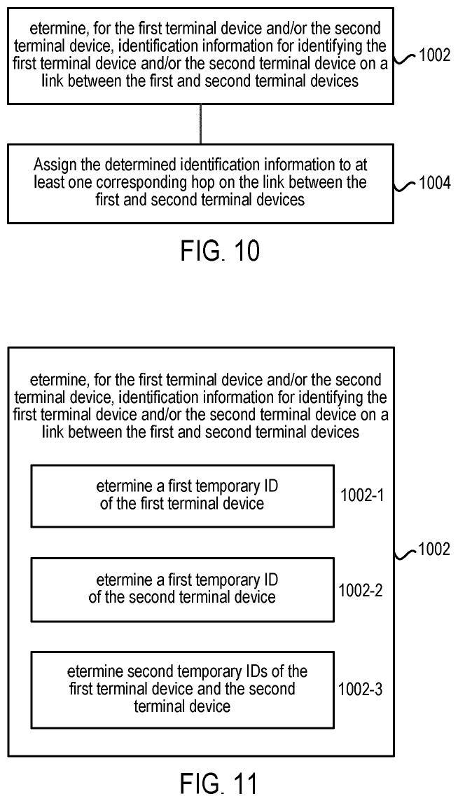

FIG. 10 is a flowchart illustrating a method performed by a third terminal device according to an embodiment of the disclosure. The method may be applicable to an environment in which the third terminal device acts as a relay between a first terminal device and a second terminal device. For example, the third terminal device may be a U2U relay described above. At block 1002, the third terminal device determines, for the first terminal device and/or the second terminal device, identification information for identifying the first terminal device and/or the second terminal device on a link between the first and second terminal devices. The identification information of a given terminal device may be used instead of a real identity of the terminal device in communication of packets, so as to conceal the real identity of the terminal device. For example, the identification information of the first/second terminal device may be used in adaptation layer headers of packets communicated on a link between the first and second terminal devices.

For example, block 1002 may be implemented as any one of blocks 1002-1 to 1002-3, as shown in FIG. 11. Block 1002-1 is applicable to the scenario where the first terminal device is a source terminal device (and thus the second terminal device is a destination terminal device). At block 1002-1, the third terminal device determines a first temporary ID of the first terminal device. The first temporary ID of the first terminal device is to be used during a link between the first terminal device and the third terminal device is established. For example, the first temporary ID may correspond to the initial local/temp ID described in the above sixth embodiment.

Block 1002-2 is applicable to the scenario where the second terminal device is a source terminal device (and thus the first terminal device is a destination terminal device). At block 1002-2, the third terminal device determines a first temporary ID of the second terminal device. The first temporary ID of the second terminal device is to be used during a link between the second terminal device and the third terminal device is established.

Block 1002-3 is applicable to the scenario where the first terminal device is a source terminal device or a destination terminal device. At block 1002-3, the third terminal device determines second temporary IDs of the first terminal device and the second terminal device. The second temporary IDs of the first terminal device and the second terminal device are to be used after a link between the first/second terminal device and the third terminal device is established. For example, the second temporary ID may correspond to the local/temp ID described in the above second to fourth embodiments.

For any one of the above scenarios, the identification information of the first terminal device and/or the second terminal device may be determined in one or more following manners: based on an L2 ID of the third terminal device; in a random manner; and based on a predetermined mathematical function. For example, the identification information of the first/second terminal device may be determined to be in one-to-one mapping to an L2 ID of the first/second terminal device.

Referring back to FIG. 10, at block 1004, the third terminal device assigns the determined identification information to at least one corresponding hop on the link between the first and second terminal devices. The determined identification information may be assigned by one or more of: RRC signaling; PC5-S signaling; Discovery signaling; MAC CE; control PDU of SDAP or PDCP or RLC or the adaptation layer; and L1 signaling. With the method of FIG. 10, it is possible to perform secure communication on the link with the identification information. For example, block 1004 may be implemented as including any one of blocks 1004-1 to 1004-3 as shown in FIG. 12. Block 1004-1 is applicable to the scenario where the identification information (e.g. second temporary IDs) of the first terminal device and the second terminal device is valid for the whole link between the first and second terminal devices. At block 1004-1, the third terminal device transmits, to the other terminal devices on the link between the first and second terminal devices, the determined identification information and an ID identifying the link between the first and second terminal devices.

Block 1004-2 is applicable to the scenario where the identification information (e.g. second temporary IDs) of the first terminal device and the second terminal device is valid on per-hop level. For example, different second temporary ID of the first terminal device may be determined for each hop on the link between the first and second terminal devices. Different second temporary ID of the second terminal device may be determined for each hop on the link between the first and second terminal devices. At block 1004-2, the third terminal device transmits, to the terminal device on each hop, the identification information of the first and second terminal devices determined for the hop, and an ID identifying the hop.

Optionally, block 1004-3 may be performed for assigning of the identification information. At block 1004-3, the third terminal device transmits, to the terminal device on the at least one corresponding hop, a time stamp or a forbid timer associated with the identification information. The time stamp indicates when the identification information is determined (or updated). The forbid timer indicates a predetermined time period during which the identification information should not be updated.

FIG. 13 is a flowchart illustrating a method performed by a third terminal device according to an embodiment of the disclosure. The method may be performed after blocks 1002-1004 are performed. At block 1307, the third terminal device receives, from the first/second terminal device, a response message in response to the assigning of the identification information. At block 1308, when the response message indicates a rejection against the identification information of the first/second terminal device, the determining (block 1002) and assigning (block 1004) of the identification information are performed again for the second terminal device. With the method of FIG. 13, possible conflict of the identification information can be solved.

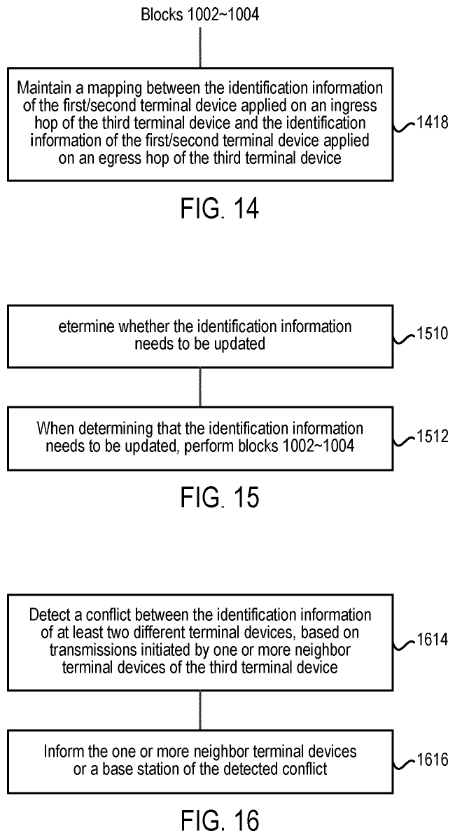

FIG. 14 is a flowchart illustrating a method performed by a third terminal device according to an embodiment of the disclosure. As shown, the method comprises blocks 1002-1004 described above and block 1418. At block 1418, the third terminal device maintains a mapping between the identification information of the first/second terminal device applied on an ingress hop of the third terminal device and the identification information of the first/second terminal device applied on an egress hop of the third terminal device. With the method of FIG. 14, the third terminal device can perform routing of packets between the first and second terminal devices.

FIG. 15 is a flowchart illustrating a method performed by a third terminal device according to an embodiment of the disclosure. For example, the method may be performed after blocks 1002-1004 are performed. At block 1510, the third terminal device determines whether the identification information needs to be updated. For example, when one or more of the conditions mentioned in the above fifth embodiment are satisfied, the third terminal device may determine that the identification information needs to be updated. At block 1512, when determining that the identification information needs to be updated, the determining (block 1002) and assigning (block 1004) of the identification information are performed again. With the method of FIG. 15, it is possible to perform secure communication on the link with the updated identification information.

FIG. 16 is a flowchart illustrating a method performed by a third terminal device according to an embodiment of the disclosure. At block 1614, the third terminal device detects a conflict between the identification information of at least two different terminal devices, based on transmissions initiated by one or more neighbor terminal devices of the third terminal device. For example, the transmissions (e.g. data and/or signaling transmissions) initiated by the one or more neighbor terminal devices may be monitored regardless whether the transmissions are intending to the third terminal device, so as to see whether there is such a conflict. At block 1616, the third terminal device informs the one or more neighbor terminal devices or a base station of the detected conflict. With the method of FIG. 16, possible conflict of the identification information can be solved.

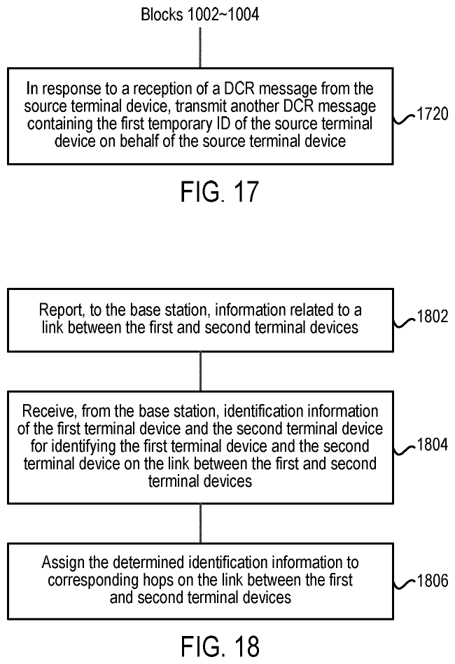

FIG. 17 is a flowchart illustrating a method performed by a third terminal device according to an embodiment of the disclosure. As shown, the method comprises blocks 1002-1004 described above and block 1720. At block 1720, in response to a reception of a DCR message from the source terminal device (e.g. the first terminal device or the second terminal device), the third terminal device transmits another DCR message containing the first temporary ID of the source terminal device on behalf of the source terminal device. As an example, the another DCR message may contain both the first temporary ID and the L2 ID of the source terminal device. As another example, the another DCR message may contain the first temporary ID of the source terminal device, without containing the L2 ID of the source terminal device. With the method of FIG. 17, it is possible for the destination terminal device to differentiate between a DCR from the source terminal device and a DCR from the third terminal device.

FIG. 18 is a flowchart illustrating a method performed by a manager terminal device according to an embodiment of the disclosure. The method may be applicable to an environment in which the manager terminal device is under coverage of a base station and is one of a first terminal device, a second terminal device and at least one third terminal device acting as a relay between the first and second terminal devices. At block 1802, the manager terminal device reports, to the base station, information related to a link between the first and second terminal devices. For example, the information related to the link between the first and second terminal devices may comprise one or more of: the number of hops on the link; an L2 ID of the first terminal device; an L2 ID of the second terminal device; an L2 ID of remaining third terminal device(s) in a case that the number of the at least one third terminal device is more than one; a Uu ID of the first terminal device; a Uu ID of the second terminal device; a Uu ID of remaining third terminal device(s) in a case that the number of the at least one third terminal device is more than one; and whether the identification information is valid on per-hop level or on end-to-end level.

At block 1804, the manager terminal device receives, from the base station, identification information of the first terminal device and the second terminal device for identifying the first terminal device and the second terminal device on the link between the first and second terminal devices. The information related to the link may be reported or the identification information may be received by one or more of: RRC signaling; MAC CE; paging message; control PDU of SDAP or PDCP or RLC or the adaptation layer; and L1 signaling. At block 1806, the manager terminal device assigns the determined identification information to corresponding hops on the link between the first and second terminal devices. Block 1806 may be implemented in a way similar to block 1004. With the method of FIG. 18, it is possible to perform secure communication on the link with the identification information.

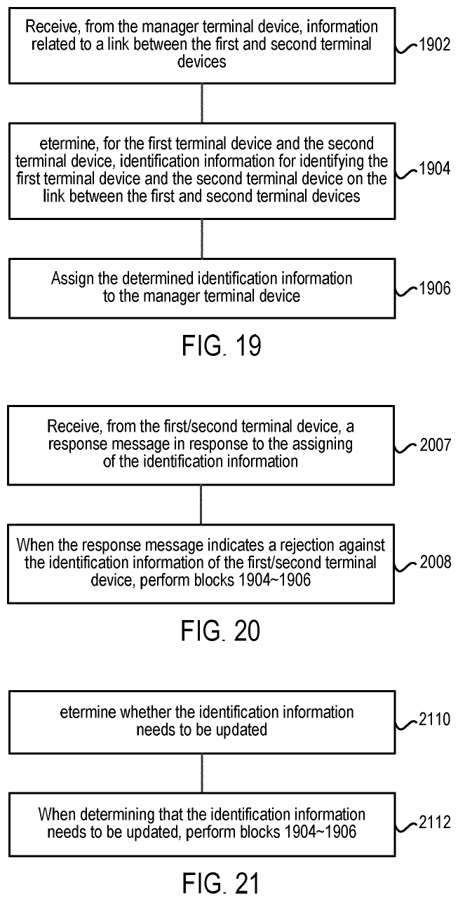

FIG. 19 is a flowchart illustrating a method performed by a base station according to an embodiment of the disclosure. The method may be applicable to an environment in which the base station connects with a manager terminal device which is one of a first terminal device, a second terminal device and at least one third terminal device acting as a relay between the first and second terminal devices. At block 1902, the base station receives, from the manager terminal device, information related to a link between the first and second terminal devices. For example, the information related to the link between the first and second terminal devices may comprise one or more of: the number of hops on the link; an L2 ID of the first terminal device; an L2 ID of the second terminal device; an L2 ID of remaining third terminal device(s) in a case that the number of the at least one third terminal device is more than one; a Uu ID of the first terminal device; a Uu ID of the second terminal device; a Uu ID of remaining third terminal device(s) in a case that the number of the at least one third terminal device is more than one; and whether the identification information is valid on per-hop level or on end-to-end level.

At block 1904, the base station determines, for the first terminal device and the second terminal device, identification information for identifying the first terminal device and the second terminal device on the link between the first and second terminal devices. The identification information of a given terminal device may be used instead of a real identity of the terminal device in communication of packets, so as to conceal the real identity of the terminal device. For example, the identification information of the first/second terminal device may be used in adaptation layer headers of packets communicated on a link between the first and second terminal devices.

For example, second temporary IDs of the first terminal device and the second terminal device may be determined. The second temporary IDs of the first terminal device and the second terminal device are to be used after a link between the first/second terminal device and the third terminal device is established. For example, the second temporary ID may correspond to the local/temp ID described in the above second to fourth embodiments. The second temporary ID of the first/second terminal device may be valid on per-hop level or on end-to-end level.

The identification information of the first/second terminal device may be determined in one or more following manners: based on an L2 ID of the first/second terminal device; in a random manner; and based on a predetermined mathematical function. The identification information of the first/second terminal device may be determined to be in one-to-one mapping to an L2 ID of the first/second terminal device.

At block 1906, the base station assigns the determined identification information to the manager terminal device. Block 1906 may optionally include transmitting, to the manager terminal device, a time stamp or a forbid timer associated with the identification information. The time stamp indicates when the identification information is determined (or updated). The forbid timer indicates a predetermined time period during which the identification information should not be updated. Optionally, the information related to the link may be received or the identification information may be assigned by one or more of: RRC signaling; MAC CE; paging message; control PDU of SDAP or PDCP or RLC or the adaptation layer; and L1 signaling. With the method of FIG. 19, it is possible to perform secure communication on the link with the identification information.

FIG. 20 is a flowchart illustrating a method performed by a base station according to an embodiment of the disclosure. The method may be performed after blocks 1902-1906 are performed. At block 2007, the base station receives, from the first/second terminal device, a response message in response to the assigning of the identification information. At block 2008, when the response message indicates a rejection against the identification information of the first/second terminal device, the determining (block 1904) and assigning (block 1906) of the identification information are performed again for the first/second terminal device. With the method of FIG. 20, possible conflict of the identification information can be solved.

FIG. 21 is a flowchart illustrating a method performed by a base station according to an embodiment of the disclosure. For example, the method may be performed after blocks 1902-1906 are performed. At block 2110, the base station determines whether the identification information needs to be updated. For example, when one or more of the conditions mentioned in the above fifth embodiment are satisfied, the base station may determine that the identification information needs to be updated. At block 2112, when determining that the identification information needs to be updated, the determining (block 1904) and assigning (block 1906) of the identification information are performed again. With the method of FIG. 21, it is possible to perform secure communication on the link with the updated identification information.

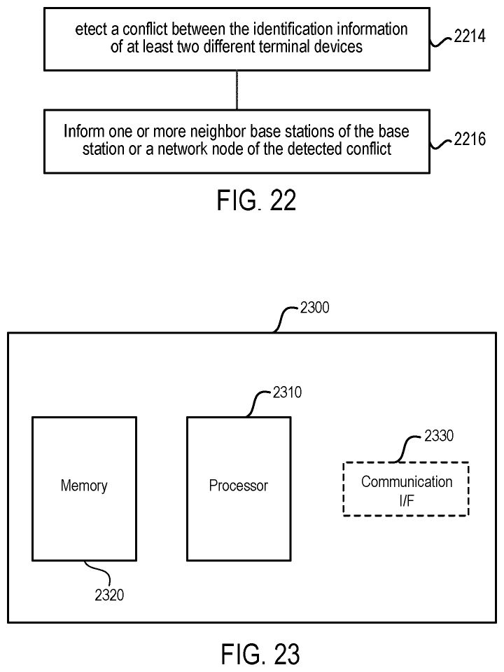

FIG. 22 is a flowchart illustrating a method performed by a base station according to an embodiment of the disclosure. At block 2214, the base station detects a conflict between the identification information of at least two different terminal devices. As an example, the base station may monitor signaling messages received from terminal devices served by the base station or signaling messages received from other base stations. As another example, the base station may monitor sidelink transmissions and/or receptions between terminal devices in its proximity. At block 2216, the base station informs one or more neighbor base stations of the base station or a network node (e.g. a core network node such as an access and mobility function (AMF) or session management function (SMF)) of the detected conflict. For example, the detected conflict may be informed to the one or more neighbor base stations by one or more of: XnAP signaling; F1AP signaling; and paging message. With the method of FIG. 22, possible conflict of the identification information can be solved.

FIG. 23 is a block diagram showing an apparatus suitable for use in practicing some embodiments of the disclosure. For example, any one of the first terminal device, the third terminal device, the manager terminal device and the base station described above may be implemented through the apparatus 2300. As shown, the apparatus 2300 may include a processor 2310, a memory 2320 that stores a program, and optionally a communication interface 2330 for communicating data with other external devices through wired and/or wireless communication.

The program includes program instructions that, when executed by the processor 2310, enable the apparatus 2300 to operate in accordance with the embodiments of the present disclosure, as discussed above. That is, the embodiments of the present disclosure may be implemented at least in part by computer software executable by the processor 2310, or by hardware, or by a combination of software and hardware.

The memory 2320 may be of any type suitable to the local technical environment and may be implemented using any suitable data storage technology, such as semiconductor based memory devices, flash memories, magnetic memory devices and systems, optical memory devices and systems, fixed memories and removable memories. The processor 2310 may be of any type suitable to the local technical environment, and may include one or more of general purpose computers, special purpose computers, microprocessors, digital signal processors (DSPs) and processors based on multi-core processor architectures, as non-limiting examples.

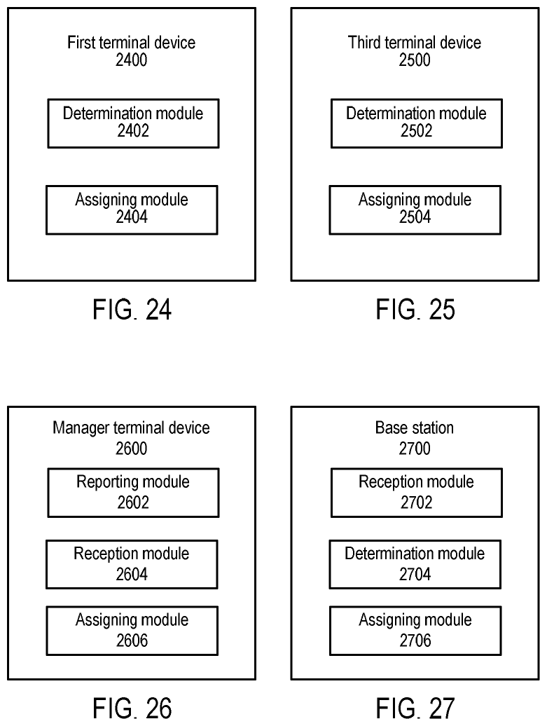

FIG. 24 is a block diagram showing a first terminal device according to an embodiment of the disclosure. The first terminal device may connect with a second terminal device via at least one third terminal device acting as a relay between the first terminal device and the second terminal device. As shown, the first terminal device 2400 comprises a determination module 2402 and an assigning module 2404. The determination module 2402 may be configured to determine, for the first terminal device and/or the second terminal device, identification information for identifying the first terminal device and/or the second terminal device on a link between the first and second terminal devices. The assigning module 2404 may be configured to assign the determined identification information to at least one corresponding hop on the link between the first and second terminal devices.

FIG. 25 is a block diagram showing a third terminal device according to an embodiment of the disclosure. The third terminal device may act as a relay between a first terminal device and a second terminal device. As shown, the third terminal device 2500 comprises a determination module 2502 and an assigning module 2504. The determination module 2502 may be configured to determine, for the first terminal device and/or the second terminal device, identification information for identifying the first terminal device and/or the second terminal device on a link between the first and second terminal devices. The assigning module 2504 may be configured to assign the determined identification information to at least one corresponding hop on the link between the first and second terminal devices.

FIG. 26 is a block diagram showing a manager terminal device according to an embodiment of the disclosure. The manager terminal device may be under coverage of a base station and may be one of a first terminal device, a second terminal device and at least one third terminal device acting as a relay between the first and second terminal devices. As shown, the manager terminal device 2600 comprises a reporting module 2602, a reception module 2604 and an assigning module 2606. The reporting module 2602 may be configured to report, to the base station, information related to a link between the first and second terminal devices. The reception module 2604 may be configured to receive, from the base station, identification information of the first terminal device and the second terminal device for identifying the first terminal device and the second terminal device on the link between the first and second terminal devices. The assigning module 2606 may be configured to assign the determined identification information to corresponding hops on the link between the first and second terminal devices.

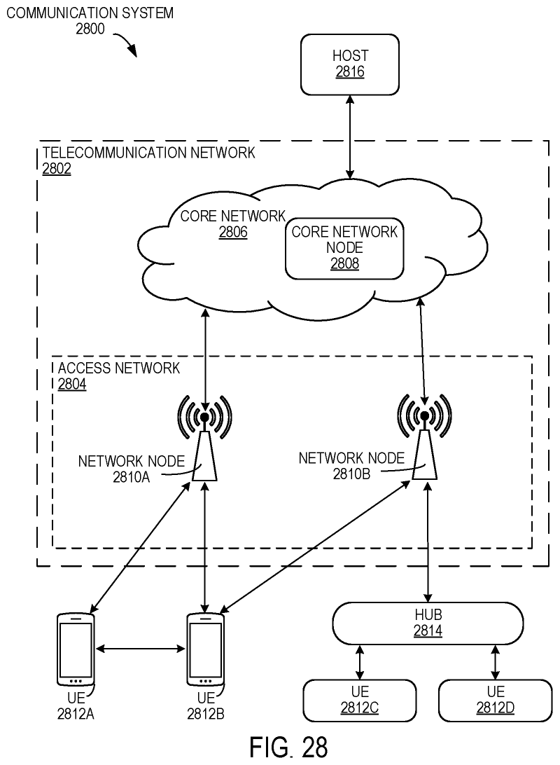

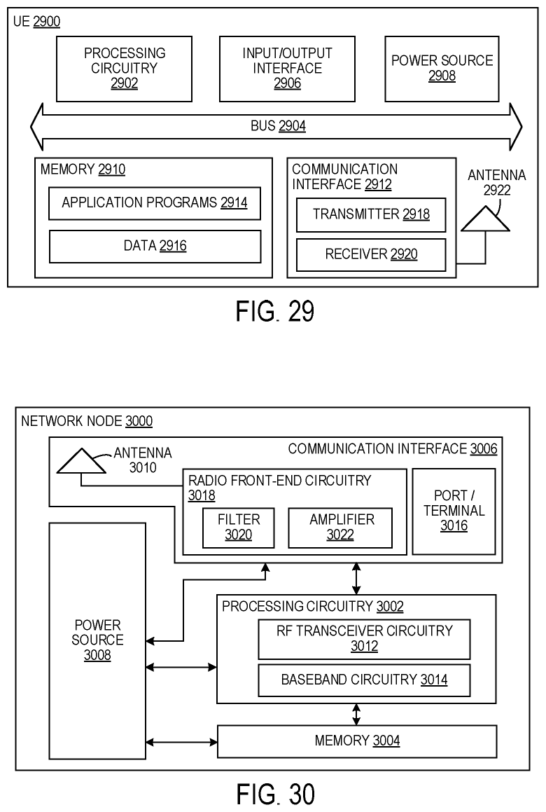

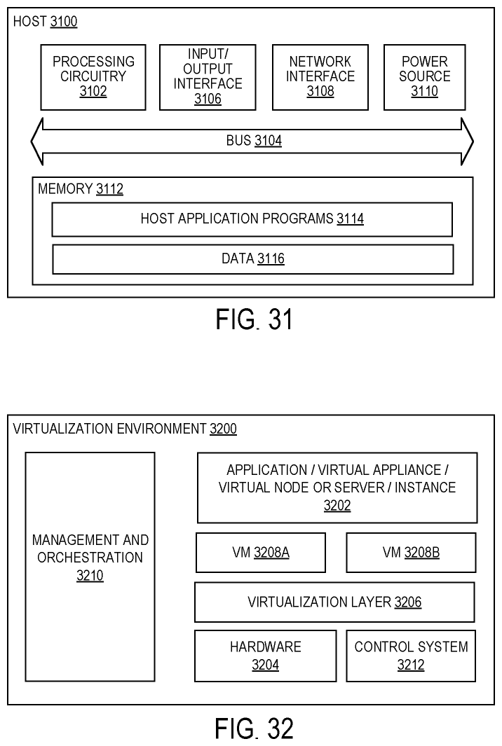

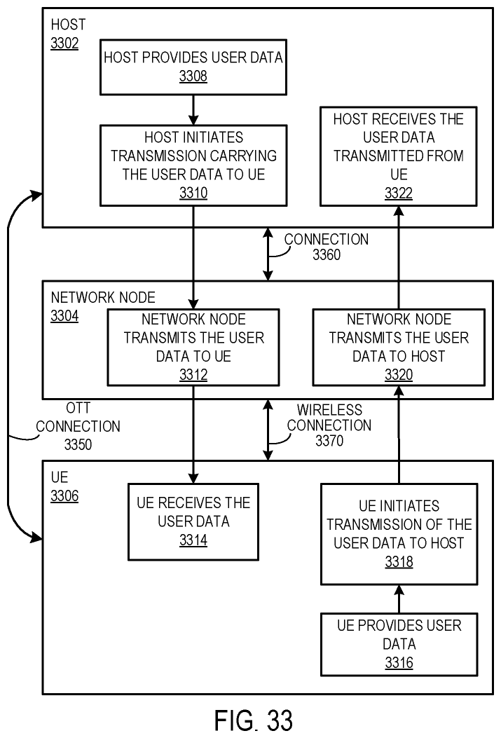

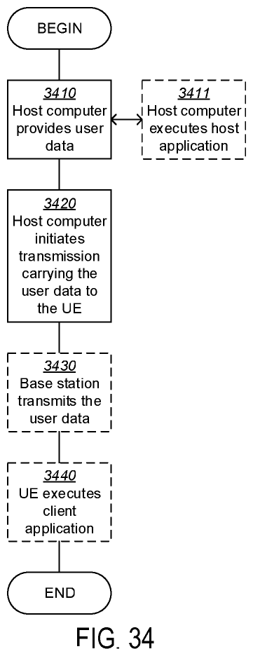

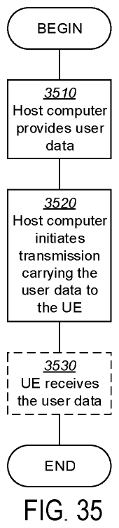

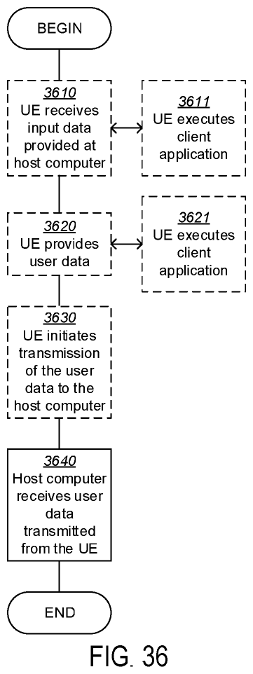

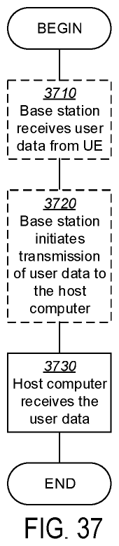

FIG. 27 is a block diagram showing a base station according to an embodiment of the disclosure. The base station may connect with a manager terminal device which may be one of a first terminal device, a second terminal device and at least one third terminal device acting as a relay between the first and second terminal devices. As shown, the base station 2700 comprises a reception module 2702, a determination module 2704 and an assigning module 2706. The reception module 2702 may be configured to receive, from the manager terminal device, information related to a link between the first and second terminal devices. The determination module 2704 may be configured to determine, for the first terminal device and the second terminal device, identification information for identifying the first terminal device and the second terminal device on the link between the first and second terminal devices. The assigning module 2706 may be configured to assign the determined identification information to the manager terminal device. The modules described above may be implemented by hardware, or software, or a combination of both.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1-59. (canceled)

60. A method performed by a third terminal device acting as a relay between a first terminal device and a second terminal device, the method comprising:
determining identification information for identifying the first terminal device and the second terminal device on a link between the first terminal device and the second terminal device; and
assigning the determined identification information to at least one corresponding hop on the link between the first terminal device and the second terminal device.

61. The method of claim 60,
wherein assigning the determined identification information comprises:
transmitting, to a terminal device on the at least one corresponding hop, a time stamp or a forbid timer associated with the identification information; and
wherein the time stamp indicates when the identification information is determined, and the forbid timer indicates a predetermined time period during which the identification information should not be updated.

62. The method of claim 60, further comprising:
determining whether the identification information needs to be updated;
wherein when determining that the identification information needs to be updated, the determining and assigning of the identification information are performed again.

63. The method of claim 60, further comprising:
detecting a conflict between the identification information of at least two different terminal devices, based on transmissions initiated by one or more neighbor terminal devices of the third terminal device; and
informing the one or more neighbor terminal devices or a base station of the detected conflict.

64. The method of claim 60, further comprising:
maintaining a mapping between the identification information of the first terminal device and/or the second terminal device applied on an ingress hop of the third terminal device and the identification information of the first terminal device and/or the second terminal device applied on an egress hop of the third terminal device.

65. The method of claim 60,
wherein the identification information of the first terminal device and/or the second terminal device is determined in one or more following manners:
based on a layer 2 (L2) identifier (ID) of the third terminal device;
in a random manner; and
based on a predetermined mathematical function.

66. The method of claim 60,
wherein the identification information of the first terminal device and/or the second terminal device is determined to be in one-to-one mapping to an L2 ID of the first/second terminal device.

67. The method of claim 60,
wherein the first terminal device is a source terminal device; and
wherein determining the identification information comprises determining a first temporary ID of the first terminal device, wherein the first temporary ID of the first terminal device is to be used during a link between the first terminal device and the third terminal device is established.

68. The method of claim 60,
wherein the second terminal device is a source terminal device; and
wherein determining the identification information comprises determining a first temporary ID of the second terminal device, wherein the first temporary ID of the second terminal device is to be used during a link between the second terminal device and the third terminal device is established.

69. The method of claim 67, further comprising:
in response to a reception of a direct communication request (DCR) message from the source terminal device, transmitting another DCR message containing the first temporary ID of the source terminal device on behalf of the source terminal device.

70. The method of claim 60,
wherein the first terminal device is a source terminal device or a destination terminal device; and
wherein determining the identification information comprises determining second temporary IDs of the first terminal device and the second terminal device, wherein the second temporary IDs of the first terminal device and the second terminal device are to be used after a link between the first/second terminal device and the third terminal device is established.

71. The method of claim 70,
wherein the second temporary IDs of the first terminal device and the second terminal device are valid for the whole link between the first terminal device and the second terminal device.

72. The method of claim 71,
wherein assigning the determined identification information comprises:
transmitting, to the other terminal devices on the link between the first terminal device and the second terminal devices, the determined identification information and an ID identifying the link between the first terminal device and the second terminal device.

73. The method of claim 70,
wherein different second temporary ID of the first terminal device is determined for each hop on the link between the first terminal device and the second terminal device; and
wherein different second temporary ID of the second terminal device is determined for each hop on the link between the first terminal device and the second terminal device.

74. The method of claim 73,
wherein assigning the determined identification information comprises:
transmitting, to the terminal device on each hop, the identification information of the first terminal device and the second terminal device determined for the hop, and an ID identifying the hop.

75. The method of claim 60, further comprising:
receiving, from the first/second terminal device, a response message in response to the assigning of the identification information; and
wherein when the response message indicates a rejection against the identification information of the first/second terminal device, the determining and assigning of the identification information are performed again for the first/second terminal device.

76. The method of claim 60,
wherein the determined identification information is assigned by one or more of:
radio resource control (RRC) signaling;
PC5 signaling (PC5-S) signaling;
Discovery signaling;
medium access control (MAC) control element (CE);
control protocol data unit (PDU) of service data adaptation protocol (SDAP) or packet data convergence protocol (PDCP) or radio link control (RLC) or an adaptation layer; and
layer 1 (L1) signaling.

77. A third terminal device comprising at least one processor and at least one memory containing instructions executable by the at least one processor, whereby the third terminal device is configured to:
act as a relay between a first terminal device and a second terminal device;
determine identification information for identifying the first terminal device and the second terminal device on a link between the first terminal device and the second terminal device; and
assign the determined identification information to at least one corresponding hop on the link between the first terminal device and the second terminal device.

78. The third terminal device of claim 77, wherein the third terminal device is further configured to determine whether the identification information needs to be updated, such that when determining that the identification information needs to be updated, the determining and assigning of the identification information are performed again.

79. The third terminal device of claim 77, wherein the third terminal device is further configured to:
maintain a mapping between the identification information of the first terminal device and/or the second terminal device applied on an ingress hop of the third terminal device and the identification information of the first terminal device and/or the second terminal device applied on an egress hop of the third terminal device.

80. The third terminal device of claim 77, wherein the third terminal device is configured such that the identification information of the first terminal device and/or the second terminal device is determined to be in one-to-one mapping to an L2 ID of the first/second terminal device.

81. The third terminal device of claim 77,
wherein the first terminal device is a source terminal device; and
wherein the third terminal device is configured such that determining the identification information comprises determining a first temporary ID of the first terminal device, wherein the first temporary ID of the first terminal device is to be used during a link between the first terminal device and the third terminal device is established.

82. The third terminal device of claim 77,
wherein the first terminal device is a source terminal device or a destination terminal device; and
wherein the third terminal device is configured such that determining the identification information comprises determining second temporary IDs of the first terminal device and the second terminal device, wherein the second temporary IDs of the first terminal device and the second terminal device are to be used after a link between the first/second terminal device and the third terminal device is established.

83. The third terminal device of claim 82,
wherein the second temporary IDs of the first terminal device and the second terminal device are valid for the whole link between the first terminal device and the second terminal device.

84. The third terminal device of claim 77,
wherein the determined identification information is assigned by one or more of:
radio resource control (RRC) signaling;
PC5 signaling (PC5-S) signaling;
Discovery signaling;
medium access control (MAC) control element (CE);
control protocol data unit (PDU) of service data adaptation protocol (SDAP) or packet data convergence protocol (PDCP) or radio link control (RLC) or an adaptation layer; and
layer 1 (L1) signaling.

85. A non-transitory computer-readable storage medium comprising, stored thereon, instructions configured so as to, when executed by at least one processor, of a third terminal device acting as a relay between a first terminal device and a second terminal device, cause the at least one processor to:
determine identification information for identifying the first terminal device and the second terminal device on a link between the first terminal device and the second terminal device; and
assign the determined identification information to at least one corresponding hop on the link between the first terminal device and the second terminal device.
